(19) United States
(12) Patent Application Publication
(10) Pub. No.: US 2022/0303777 A1
(43) Pub. Date: Sep. 22, 2022

(54) System for Communicating Network Security to Mobile Devices

(71) Applicant: Paul B. Barringer, II, Norwalk, CT (US)

(72) Inventor: Paul B. Barringer, II, Norwalk, CT (US)

(21) Appl. No.: 17/204,560

(22) Filed: Mar. 17, 2021

(51) Int. Cl. H04W 12/30; H04L 29/06; H04L 29/08

(52) U.S. Cl. CPC H04W 12/30; H04L 63/20; H04L 63/1433; H04L 67/36

(57) ABSTRACT

A system for communicating network security to mobile devices is provided having a computer, a database storing a plurality of phone numbers each associated with one of a plurality of companies, a mobile device in wireless communication with said computer and having a phone number matching one of the plurality of phone numbers in said database, the computer retrieving the company associated with said mobile device phone number from said database, and said computer sending security data representing the security of a network controlled by the company to said mobile device.

### CROSS-REFERENCE TO RELATED APPLICATIONS

### Technical Field

The present invention relates to a novel system for communicating network security to mobile devices. Specifically, the system is used for communicating information regarding a company's network security to a mobile device associated with the company.

### BACKGROUND

Companies that own or operate their own computer networks often struggle with network security. While these companies can hire security specialists to analyze and improve their computer networks, this is costly and time consuming.

In addition, most people in a company will not know how protected their devices and personal information are when they connect to a workplace network. This is especially important now that many users bring their own devices to their workplaces.

Furthermore, while third-party computer security firms may have information regarding a specific company's network security because of the computer security firm's operations, these computers security firms have no way to transmit that information to network owners or operators. In fact, they may not have the name or contact information for the company.

### SUMMARY

For these and other reasons known to a person of an ordinary skill in the art, what is needed is a system for communicating network security to mobile devices.

A goal of the present invention is to provide network security data for company to mobile devices associated with that company.

Another goal of the present invention is to associate a mobile device with the company's computer network via the mobile device's phone number.

Another goal of the present invention is to provide network security data for a company to a mobile device through an app installed on the mobile device.

Another goal of the present invention is to provide network security data as a score.

Another goal of the present invention is to make recommendations to improve the network security of a network.

Another goal of the present invention is to simplify implementing improvements to network security.

Another goal of the present invention is to retrieve security data from third party security data sources.

In one aspect of the present invention, a system for communicating network security to mobile devices is provided having a computer, a database storing a plurality of phone numbers each associated with one of a plurality of companies, a mobile device in wireless communication with said computer and having a phone number matching one of the plurality of phone numbers in said database, the computer retrieving the company associated with said mobile device phone number from said database, and said computer sending security data representing the security of a network controlled by the company to said mobile device.

### BRIEF DESCRIPTION OF THE DRAWINGS

FIG. 1 shows a schematic diagram of the presently disclosed system.

### DETAILED DESCRIPTION

The present invention will now be described by referencing the appended figures.

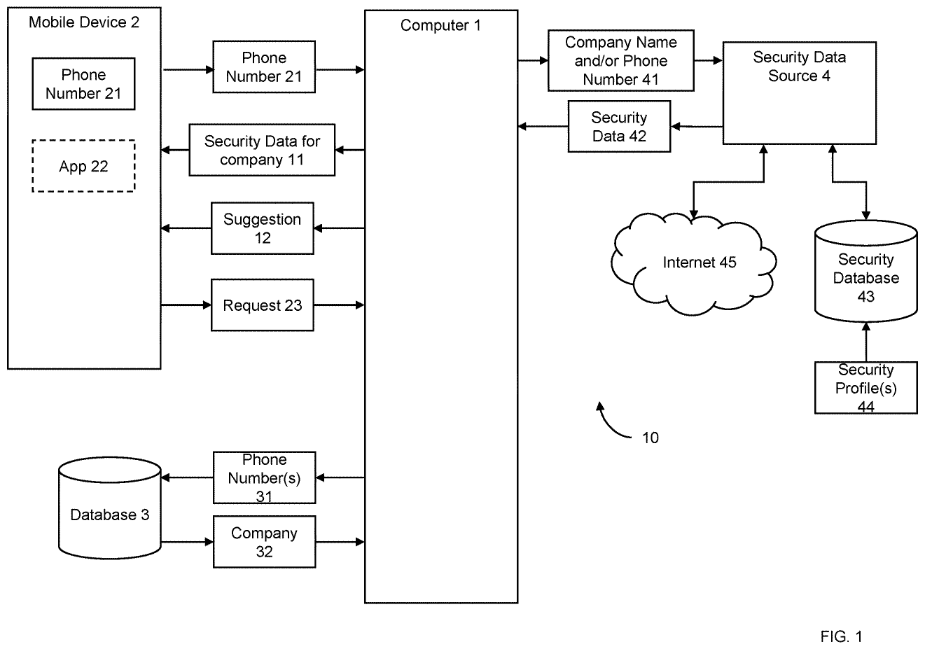

Referring to FIG. 1, the present disclosure describes a system 10 for communicating network security to mobile devices.

The system 10 includes a computer 1. The computer 1 may be a processor, remote computer, computer server, network, or any other computing resource.

The computer 1 may be in data communication with a mobile device 2. The mobile device 2 may be a computer, laptop, smartphone, tablet, or other electronic device, capable of transmitting data to the computer 1. The mobile device 2 may be associated with a company or other organization that manages, owns, or operates a network. The mobile device 2 has a phone number 21. The mobile device 2 may have an app 22 which may be used to display and receive input regarding the system 10.

The computer 1 may receive the phone number 21 from the mobile device 2.

The computer 1 may also be in communication with a database 3. The database 3 may be a storage drive or array accessible to computer 1, or cloud storage. The database 3 may store information regarding the system 10. The database 3 may store a list of phone numbers 31 that are associated with companies 32. The database 3 may be managed or owned by a mobile network operator or provider.

The computer 1 may query the database 3 using the phone number 31 associated with a mobile device to retrieve a company 32 associated with the phone number 31.

The computer 1 may be in data communication with a security data source 4. The security data source 4 may be a computer or other device associated with a computer security firm or another third party with information regarding a company's network security. The security data source may be a cyber security solution deployed in the company network such as an endpoint, IPS, IDS, or firewall.

Computer 1 may send at least one of the company name and/or phone number 41 to the security data source 4. The security data source 4 may use at least one of the company name and phone number 41 to retrieve and send security data 42 regarding the network associated with the mobile device's 2 associated company to the computer 1.

In the instances where, for example, the security data source 4 is a computer security firm, a security data source 4 may be in data communication with the security database 43. The security database 43 may have a security profile 44 for the network associated with the company. The security data source 4 may query the security database 43 to retrieve this security profile 44. The security data source 4 may transmit the retrieved security data 42 to the computer 1.

In other instances where for example the security data source 4 does not have a security profile 44 stored in a security database 43, or if the security profile 44 is out of date, the security data source 4 can scan the network over the Internet 45 to determine security information regarding the network. The security data source 4 may scan the network controlled by the company to determine vulnerabilities. Scanning can include running a computer program against a plurality of IP addresses. The IP addresses scanned may be known or identified at or before runtime. Security data 42 may be transmitted to the computer based on the results of the scan. The security data source 4 may optionally save the security information retrieved from the Internet as a security profile 44 in the security database 43.

Security data 42 may include additional information such as a timestamp, identification, or other useful information when transmitted to the computer 1.

The computer 1 may send the retrieved security data 42 to the mobile device 2 as security data 11. Security data 11 may include a score based on the security data 42. The score may represent network security, or aspects thereof, on a scale of one to ten, for example. The security data 11 may be displayed in the app 22.

The computer 1 may also send my suggestion 12 to the mobile device 2 to improve the security of the company's network. The suggestion 12 may be based at least in part on the security data 42. In response to the suggestion 12, the mobile device 2 may send a request 23 to the computer 1 to implement this suggestion 12. The implementation may be automatic or may require an on-site or remote presence of a technician to implement the suggestion 12.

Although the invention has been illustrated and described herein with reference to a preferred embodiment and a specific example thereof, it will be readily apparent to those of ordinary skill that the art that other embodiments and examples may perform similar functions and/or achieve user experiences. All such equivalent embodiments and examples are within the spirit and scope of the present invention, are contemplated thereby, and are intended to be covered by the following claims.

In compliance with the statute, the present teachings have been described in language more or less specific as to structural and methodical features. It is to be understood, however, that the present teachings are not limited to the specific features shown and described, since the systems and methods herein disclosed comprise preferred forms of putting the present teachings into effect. The present disclosure is to be considered as an example of the invention, and is not intended to limit the invention to a specific embodiment illustrated by the figures above or description below.

For purposes of explanation and not limitation, specific details are set forth such as particular architectures, interfaces, techniques, etc. in order to provide a thorough understanding. In other instances, detailed descriptions of well-known devices, circuits, and methods are omitted so as not to obscure the description with unnecessary detail.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second,” etc. for different features/components of the present disclosure are only intended to distinguish the features/components from other similar features/components and not to impart any order or hierarchy to the features/components. As used herein, the term “and/or” includes any and all combinations of one or more of the associated listed items. As used herein, the term “application” is intended to be interchangeable with the term “invention”, unless context clearly indicates otherwise. As used herein, the term “virtual space” is intended to mean the set of possible user locations, where a location is specified by parameters assigned to each user. These parameters are modifiable by the user, thereby rendering the space navigable.

To aid the Patent Office and any readers of any patent issued on this application in interpreting the claims appended hereto, Applicant that it does not intend any of the claims or claim elements to invoke 35 U.S.C. 112(f) unless the words “means for” or “step for” are explicitly used in the particular claim.

While the present teachings have been described above in terms of specific embodiments, it is to be understood that they are not limited to these disclosed embodiments. Many modifications and other embodiments will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings. In describing the invention, it will be understood that a number of techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims. Furthermore, the specification and claims should be read with the understanding that the virtual space, or spaces, and/or the number of participants using the invention simultaneously which are implied or described herein do not limit the scope of the invention or the claims.

What is claimed is:

1. A system for communicating network security to mobile devices, comprising:
a computer;
a database storing a plurality of phone numbers each associated with one of a plurality of companies;
a mobile device in wireless communication with said computer and having a phone number matching one of the plurality of phone numbers in said database;
the computer retrieving the company associated with said mobile device phone number from said database;
said computer sending security data representing the security of a network controlled by the company to said mobile device.

2. The system of claim 1, further comprising a database storing a plurality of security profiles each associated with one of a plurality of companies, and wherein the security data sent to said mobile device is retrieved from said database using the company as an identifier.

3. The system of claim 1, wherein the computer sends suggestions to improve the security of said network.

4. The system of claim 1, wherein the computer receives a request to implement the suggestion received.

5. The system of claim 1, wherein the computer consolidates the data representing the security of a network into a score for displaying on said mobile device.

6. The system of claim 1, wherein the mobile device is a smart phone having an app for displaying said data representing the security of said network.

7. The system of claim 1, further comprising software executing on said computer for matching the company associated with said mobile device with the network controlled by the company.

8. The system of claim 1, wherein the computer receives the security data from a security data source.

9. The system of claim 8, wherein the security data source is a third party.

10. The system of claim 8, wherein the security data source is a cyber security solution deployed in the company network such as an endpoint, IPS, IDS, or firewall.

11. The system of claim 8, wherein the security data source scans the network controlled by said company to determine vulnerabilities.

12. The system of claim 11, wherein the scanning includes running a computer program against a plurality of IP addresses.
